(19) United States
(12) Patent Application Publication
(10) Pub. No.: US 2008/0129181 A1
(43) Pub. Date: Jun. 5, 2008

(54) Electrodes And To Tube Manufacture

(75) Inventors: David Steven Barratt, Blackburn (GB); Derek John Holden, Blackburn (GB)

Correspondence Address: HUSCH BLACKWELL SANDERS LLP, 720 OLIVE STREET, SUITE 2400, ST. LOUIS, MO, 63101, US

(73) Assignee: BLACKBURN MICROTECH SOLUTIONS LIMITED, Lancashire (GB)

(21) Appl. No.: 11/720,015

(22) PCT Filed: Nov. 17, 2005
(86) PCT No.: PCT/GB05/04431

§ 371 Date: Jun. 7, 2007

(30) Foreign Application Priority Data
Nov. 24, 2004 (GB) 0425791.1

(51) Int. Cl. H01J 1/304; H01J 9/02; H01J 61/09

(52) U.S. Cl. 313/356; 313/355; 445/50; 445/35; 445/67

(57) ABSTRACT

There is provided apparatus (100) for forming a tube (9) by bending a metal sheet (11). The apparatus (100) comprises a forming station (102) comprising a forming pin (101) around which a metal sheet (11) can be wrapped and a plurality of form fingers (110, 120, 130, 140) radially spaced around the forming pin (101) and moveable relative thereto. Also provided are electrode emission source components (1) The components (1) comprise an open ended tube (9) and a-cap (13), wherein the tube (9) is formed from* a metal sheet (11) which is formed into a tubular configuration. Further provided are electrodes, electrical apparatus and methods of forming tubes.

### FIELD OF THE INVENTION

The present invention relates to electrodes, electrode components, apparatus comprising electrodes and to methods of manufacturing electrodes and electrode components as well as tubes and tubular bodies and to apparatus for use in said methods.

### BACKGROUND TO THE INVENTION

There are known electrodes having a range of constructions and applications. Cold cathode electrodes for example have been found effective for lighting applications including cold cathode fluorescent lamps (CCFL) as backlights for LCD displays. However, such electrodes are of a small size and can thus be difficult to manufacture.

A known electrode comprises Molybdenum and has a tubular body which is blind at one end and to which end a stem (or pin) is attached. The tubular body is formed in a single part by a deep-drawing process and may consequently have a number of disadvantages.

The deep-drawing process can be inefficient resulting in wastage of materials and consequently increased manufacturing costs.

Additionally, with a deep drawing process the length of the tubular body may be restricted to a maximum of around 5 times its diameter. However, for longer electrode life and greater lamp brightness, longer electrodes having higher surface areas are desirable.

To improve the electrodes performance and/or lifespan it may also be desirable to coat the inner and/or outer surfaces of the tubular body. However, it may be difficult to coat the inside of the body, particularly if the body is long.

There thus remains a need for alternative electrodes and manufacturing methods.

Accordingly, the present invention aims to address at least one disadvantage associated with the prior art whether discussed herein or otherwise.

### SUMMARY OF THE INVENTION

According to the present invention in a first aspect there is provided an electrode emission source component comprising an open ended tube and a cap wherein the tube is formed from a metal sheet which is formed into a tubular configuration and the cap is located onto the tube to form a tubular body which is blind at one end.

The metal sheet may be rolled into a tubular configuration. Suitably, the metal sheet is bent into a tubular configuration.

Suitably, the tubular body has a length of between 1 and 20 times its diameter, preferably between 3 and 15 times its diameter, for example around 10 times its diameter.

Suitably, the length of the tube is at least 5 times its diameter, for example at least 6, 7, 8, 9, 10, 11 or 12 times its diameter. Such ratios may result in a lamp comprising an electrode which comprises the electrode emission source component having a longer lifetime and/or greater brightness than lamps employing known electrodes.

Suitably, the electrode emission source component has an outer diameter of between 0.5 and 5 mm.

Suitably, the electrode emission source component has a length of between 0.5 and 12 mm.

Suitably, the cap has walls having a thickness of between 0.01 and 0.1 mm, preferably between 0.02 and 0.1 mm, for example around 0.055 mm.

Suitably, the metal sheet has a thickness of between 0.01 and 0.01 mm, preferably between 0.02 and 0.1 mm, for example around 0.08 mm. The tube may thus have a wall having a thickness of between 0.01 and 0.1 mm, preferably between 0.02 and 0.1 mm, for example around 0.08 mm. The wall may have double this thickness where edges of the metal sheet overlap.

Suitably, the tube has a substantially circular cross section.

Suitably, the tube comprises a bent metal sheet which is substantially planar prior to being formed into the tube.

Suitably, the tube comprises a bent metal sheet which is substantially rectangular prior to being formed into the tube.

Suitably, opposed first and second edges of the metal sheet lie substantially adjacent one another when formed into the tube.

Suitably, first and second edge regions of the metal sheet overlap when formed into the tube. The tube may thus have a double wall thickness at a seam which closes the tube circumferentially.

Suitably, the first and second edge regions of the metal sheet overlap by between 0.1% and 10% of the circumference of the tube, for example by between 0.5% and 8%.

Suitably, the cap comprises a unitary body. Suitably, the cap is formed by deep-drawing. Alternatively, the cap may be formed by extrusion.

Suitably, the cap comprises a generally cylindrical hollow form. Suitably, the cap comprises a tube which is blind at one end and open at the other.

Suitably, the cap holds the bent metal sheet in a tubular configuration. Suitably, the cap is arranged to locate over an end of the tube such that the tube fits snugly therein.

Suitably, the cap is located over the tube such that the cap overlaps an end region of the tube by between 0.1 and 30% of the tube length, preferably by between 0.5 and 20% of the tube length, for example by between 2 and 15% of the tube length.

Suitably, the cap overlaps the tube by between 0.1 mm and 10 mm. Suitably, the cap overlaps the tube by at least 0.1 mm, preferably by at least 0.3 mm, for example by at least 0.5 mm.

The overlap of the cap and tube may be arranged to provide an electrode emission source component having a double wall thickness at a region which may be prone to develop holes when the component is employed as an emission source in an electrode. This construction may thus result in the electrode component having a longer life than a component having a single thickness wall throughout its extent.

Suitably, the electrode component comprises one or more welds to secure the bent metal sheet in a tubular configuration. Suitably, one or more welds are formed to join overlapping parts of the metal sheet. Suitably, overlapping parts of the metal sheet are laser welded together. Suitably, the welds are spot welds.

Suitably, the cap is secured to the tube by one or more welds. Suitably, the cap is secured to the tube by a plurality of welds. Suitably, the tube and cap are laser welded together. Suitably, the welds are spot welds.

Suitably, the cap is secured to the tube by a first weld located at a region in which the first and second edges of the metal sheet overlap and in which the tube and cap overlap. Suitably, the tube and cap are secured by one or more further welds, preferably by two further welds spaced between 90 and 150 degrees, for example around 120 degrees, either side of the first weld.

The tube may comprise a metal sheet which comprises a pure metal. Alternatively, the tube may comprise a metal sheet which comprises an alloy.

Suitably, the metal sheet has a melting point of greater than 1100° C. Suitably, the metal sheet has a thermal conductivity of between 0.2 Watts/cm².° C. and 5.0 Watts/cm².° C. Suitably, the metal sheet has a coefficient of linear expansion of between 1×10⁻⁶/° C. and 30×10⁻⁶/° C. at ambient temperature.

Suitably, the tube comprises a metal sheet which comprises a transition metal. Suitably, the metal sheet comprises a metal selected from the group consisting of Nickel (Ni), Molybdenum (Mo), Niobium (Nb), Tantalum (Ta) and Tungsten (W). Suitably, the metal sheet comprises Molybdenum. Alternatively, the metal sheet may comprise Nickel which may be coated on at least one side.

The cap may comprise a pure metal. Alternatively, the cap may comprise an alloy.

Suitably, the cap has a melting point of greater than 1100° C. Suitably, the cap has a thermal conductivity of between 0.2 Watts/cm².° C. and 5.0 Watts/cm².° C. Suitably, the cap has a coefficient of linear expansion of between 1×10⁻⁶/° C. and 30×10⁻⁶/° C. at ambient temperature.

Suitably, the cap comprises a transition metal. The cap may comprise a metal selected from the group consisting of Nickel (Ni), Molybdenum (Mo), Niobium (Nb), Tantalum (Ta) and Tungsten (W). Suitably, the cap comprises Molybdenum.

The cap and tube may comprise the same metal. Alternatively, the cap and tube may comprise distinct metals. The tube and cap may thus be made from distinct materials chosen for their specific properties and functional performance in the overall electrode component combination.

The inner face of the electrode component may comprise a surface coating.

The surface coating may be provided on the tube and cap or just on the tube or just on the cap.

The tube may comprise a metal sheet which is provided with a surface coating on a first side and then formed into a tube such that said first side forms the inner face of the tube. Thus, it may be possible to form a tubular body having a tube of substantial length which is coated substantially evenly over its inner extent.

The surface coating may be arranged to improve the performance and/or lifespan of the electrode component.

The surface coating may have a thickness of between 0.001 mm and 0.1 mm.

The surface coating may comprise micro and/or nano sized particles to increase the surface area of the electrode component. This may result in higher brightness and/or lower operating temperatures for lamps employing electrodes comprising the electrode emission source component.

The surface coating may comprise a metal which has a higher activity than the metal forming the component that it coats. A metal having a higher activity may have an increased resistance to ion bombardment and/or improved electron emission properties which may be due to the metal having a lower work function and/or higher electrical conductivity. The surface coating may comprise Molybdenum or Tungsten or other suitable elements or alloys. The electrode emission source component may thus be constructed from a cap and/or tube comprising a metal, such as Nickel, coated with a more active but more expensive metal, such as Molybdenum or Tungsten. This may allow effective electrodes to be manufactured more economically.

The surface coating may comprise a material having a low work function and/or high resistance to ion bombardment. The surface coating may for example comprise diamond or polycrystalline silicon.

The outer face of the electrode component may comprise a surface coating.

The surface coating may be provided on the tube and cap or just on the tube or just on the cap.

The tube may comprise a metal sheet which is provided with a surface coating on a second side and then formed into a tube such that said second side forms the outer face of the tube.

The surface coating may be arranged to improve the performance and/or lifespan of the electrode component.

The surface coating may comprise a coating as described in relation to the inner face of the electrode emission source component.

The surface coating applied to the outer face may be the same as that applied to the inner face or may be distinct there from. Thus, a surface coating applied to the second side of the metal sheet may be the same as that applied to a first side of the metal sheet or may be distinct there from.

A surface coating may be applied to a part of the electrode emission source component by a number of known methods, for example any of sputter coating, electrochemical deposition, metal-organic vapour phase deposition, in-situ precipitation, sol-gel processes, spraying, brushing or coil coating may be suitable.

Once the coating is applied it may be necessary to convert it to a suitable metallic form by a thermal and/or chemical treatment before the part of the electrode emission source component is employed to manufacture the electrode emission source component.

The tube may comprise a metal sheet which is provided with a surface coating which is then converted into a suitable metallic form prior to the metal sheet being formed into a tube.

According to a second aspect of the present invention there is provided an electrode comprising an electrode emission source component according to the first aspect and a stem attached to the cap of the electrode emission source component.

The stem may be formed integrally with the cap. The stem may be welded to the cap.

Suitably the stem extends substantially parallel to the axis of the tube. Suitably, the tube and stem have a substantially common axis.

The stem may comprise a pure metal. Alternatively, the stem may comprise an alloy.

Suitably, the stem has a melting point of greater than 1100° C. Suitably, the stem has a thermal conductivity of between 0.2 Watts/cm².° C. and 5.0 Watts/cm².° C. Suitably, the stem has a coefficient of linear expansion of between 1×10⁻⁶/° C. and 30×10⁻⁶/° C. at ambient temperature.

Suitably, the stem comprises a transition metal. The stem may comprise a metal selected from the group consisting of Nickel (Ni), Molybdenum (Mo), Niobium (Nb), Tantalum (Ta) and Tungsten (W). The stem may comprise KOVAR (an Iron, Nickel, Cobalt and Chromium alloy).

Suitably, the stem comprises the same material as the cap.

Suitably, the electrode comprises a glass ring mounted on the stem. The glass ring may provide an attachment point by which the electrode may be secured into a housing.

According to a third aspect of the present invention there is provided an electrical apparatus comprising an electrode according to the second aspect.

The electrical apparatus may comprise a lighting apparatus. The electrical apparatus may comprise a cold-cathode fluorescent lamp, used for example in a back light for an LCD display.

According to a fourth aspect of the present invention there is provided an apparatus for forming a tube by bending a metal sheet, the apparatus comprising a forming station comprising a forming pin around which said metal sheet can be wrapped and a plurality of form fingers radially spaced around the forming pin and moveable relative to the forming pin for wrapping the metal sheet around the forming pin.

Suitably, the forming pin comprises a cylinder having a circular cross-section. Suitably, the axis of the forming pin is arranged to extend substantially vertically.

Suitably, the apparatus is arranged to locate the metal sheet substantially tangentially to the forming pin.

Suitably, each form finger is moveable relative to the axis of the forming pin.

Suitably, the apparatus comprises three or more, for example four or more form fingers. Suitably, the apparatus comprises only four form fingers.

Suitably, the apparatus comprises feed means arranged to feed a metal sheet to the forming station.

Suitably, the metal sheet comprises a metal tape. The feed means may thus be arranged to feed metal tape to the forming station.

Suitably, the apparatus comprises a cutter arranged to cut a length of tape from a supply of tape to provide a metal sheet which can be formed into a tube.

Suitably, the apparatus is arranged to feed a metal tape from a tape supply to the forming station and then cut the tape to provide a metal sheet, by separating a length of tape from the tape supply, and then form the metal sheet into a tube.

Suitably, the feed means is arranged to feed the metal tape into the forming station substantially tangentially to the forming pin.

Suitably, the apparatus is arranged such that the metal tape is fed into the forming station such that it lies near to, suitably within 5 mm, preferably within 0.1 mm of the forming pin. Suitably the apparatus is arranged such that the metal tape substantially does not engage the forming pin as it is fed into the forming station.

Suitably, a first form finger is arranged to move substantially perpendicular to the direction in which the metal tape is fed into the forming station.

Suitably, the first form finger is moveable substantially linearly. Suitably, the first form finger is moveable substantially perpendicularly to the axis of the forming pin.

Suitably, the first form finger is moveable to a clamping position such that it can clamp the metal tape against the forming pin to hold it in position substantially without deforming the tape. The tape may thus be held in position whilst a length of tape is cut by the cutter to form the metal sheet.

Suitably, the apparatus is arranged such that once a length of tape is cut by the cutter to form the metal sheet the metal sheet may be held in position by the forming pin and first form finger.

Suitably, the apparatus is arranged such that during the tube forming process at any given time whilst the metal sheet is being wrapped around the forming pin a part of the metal sheet is clamped between the forming pin and a form finger. Thus, the apparatus may be arranged to precisely form tubes.

Suitably, the first form finger is moveable to a wrapping position in which it can cause the metal sheet to bend around the forming pin. Suitably, the first form finger is arranged to engage a mid region of the metal sheet.

Suitably, the wrapping position of the first form finger lies closer to the forming pin than the clamping position. The metal sheet may thus remain clamped between the first form finger and forming pin when the form finger is in the wrapping position.

Suitably, the first form finger comprises a tip having a forming face. Suitably, the forming face comprises a concave arc arranged to engage the metal sheet when in the wrapping position.

Suitably, the forming face comprises an arc of around 180 degrees.

Suitably, the forming face is arranged to substantially correspond to the outer surface of the forming pin.

Suitably, the first form finger is arranged to wrap the metal sheet around the forming pin to form a U shaped arc, suitably of around 180 degrees.

The first form finger may be mounted to an actuator arranged to move it linearly relative to the axis of the forming pin.

Suitably, the first form finger remains in contact with the metal sheet from the time it first engages the sheet until the sheet has been wrapped into a tube.

The apparatus may be arranged such that the tape is fed and cut to provide a cut edge lying closer to the clockwise side of the first form finger than to the anti-clockwise side thereof. Alternatively, the apparatus may be arranged such that the tape is fed and cut to provide a cut edge lying closer to the anti-clockwise side of the first form finger than to the clockwise side thereof.

The form fingers suitably operate sequentially and their relative positions may depend upon the direction from which the tape is fed. For convenience, all references to relative directions herein relate to a situation in which the tape is fed from a clockwise side of the form finger. It will however be appreciated that the alternate embodiment in which the tape is fed from an anti-clockwise side of the form finger are encompassed by the present invention.

Suitably, the apparatus comprises a second form finger. Suitably, the second form finger is arranged to move substantially linearly. Suitably, the second form finger is arranged to move substantially perpendicularly to the axis of the forming pin.

Suitably, the second form finger has a tip having a forming face. Suitably, the forming face comprises a concave arc.

Suitably, the forming face comprises an arc of around 30 degrees.

Suitably, the forming face is arranged to substantially correspond to the outer surface of the forming pin.

The second form finger may be mounted to an actuator arranged to move it linearly relative to the axis of the forming pin.

Suitably, the second form finger is arranged to move on a path which is radially disposed relative to the path on which the first form finger is arranged to move by between 70 and 110 degrees, for example by around 90 degrees. Suitably, the second form finger is radially disposed relative to the first form finger by said angle in an anti-clockwise direction.

Suitably, the second form finger is arranged to move substantially perpendicularly to the first form finger.

Suitably, the second form finger is moveable to a wrapping position in which it can cause a metal sheet to bend around the forming pin. Suitably, the second form finger is arranged to engage a first edge region of the metal sheet.

Suitably, the metal sheet is clamped between the second form finger and the forming pin when the second form finger is in the wrapping position.

Suitably, the apparatus comprises a third form finger. Suitably, the third form finger is arranged to move axially relative to the forming pin. Suitably, a tip of the third form finger is arranged to move on an arcuate path as it approaches the forming pin.

Suitably, the third form finger is arranged to move on a path which is substantially equidistantly spaced from that of the first and second form fingers.

Suitably, the third form finger is arranged to move on a path which is radially disposed relative to the path on which the first form finger is arranged to move by between 100 and 160 degrees, for example by around 130 to 140 degrees. Suitably, the second form finger is radially disposed relative to the first form finger by said angle in a clockwise direction.

Suitably, the third form finger has a tip having a forming face. Suitably, the forming face comprises a concave arc.

Suitably, the forming face comprises an arc of around 90 degrees.

Suitably, the forming face is arranged to substantially correspond to the outer surface of the forming pin.

Suitably, the third form finger is moveable to a wrapping position in which it can cause a metal sheet to bend around the forming pin. Suitably, the third form finger is arranged to engage the metal sheet between a mid region, engaged by a first form finger, and a second edge region of the metal sheet.

Suitably, the metal sheet is clamped between the third form finger and the forming pin when it is in the wrapping position.

Suitably, the third form finger is arranged to move generally perpendicularly to the axis of the forming pin but for a tip thereof to follow an arcuate path as it approaches the forming pin.

The third form finger may be mounted to an actuator arranged to move it linearly relative to the axis of the forming pin. The third form finger may be pivotally mounted to the actuator and the apparatus may comprise an engagement pin arranged to engage the third form finger and cause it to pivot relative to the actuator as it approaches a wrapping position. The tip of the second form finger may thus be caused to follow an arcuate path as it moves towards the forming pin and rotates relative to the actuator and forming pin simultaneously. This action may minimise the risk of the third form finger creating kinks in the metal sheet as it engages it.

Suitably, the third form finger remains in contact with the metal sheet from the time it first engages the sheet until the sheet has been wrapped into a tube.

Suitably, the third form finger is arranged to move to its wrapping position after the first and second form fingers move to their wrapping positions.

Alternatively, the third form finger may be arranged to move to its wrapping position after the first form finger moves to its wrapping position but before the second form finger moves to its wrapping position.

Suitably, the apparatus comprises a fourth form finger. Suitably, the fourth form finger is arranged to move linearly. Suitably, the fourth form finger is arranged to move substantially perpendicularly to the axis of the forming pin.

Suitably, the fourth form finger has a tip having a forming face. Suitably, the forming face comprises a concave arc.

Suitably, the forming face comprises an arc of around 70 degrees.

Suitably, the forming face is arranged to substantially correspond to the outer surface of the forming pin.

The fourth form finger may be mounted to an actuator arranged to move it linearly relative to the axis of the forming pin.

Suitably, the fourth form finger is arranged to move on a path which is radially disposed relative to the path on which the first form finger is arranged to move by between 100 and 150 degrees, for example by around 130 to 140 degrees. Suitably, the fourth form finger is radially disposed relative to the first form finger by said angle in an anti-clockwise direction.

Suitably, the fourth form finger is moveable to a wrapping position in which it can cause a metal sheet to bend around the forming pin. Suitably, the fourth form finger is arranged to engage the metal sheet near to a second edge region thereof.

Suitably, the apparatus is arranged such that the second form finger is removed from contact with the metal sheet before the fourth form finger engages the metal sheet. Suitably, the first and third form fingers remain in contact with the metal sheet.

Suitably, the metal sheet is clamped between the fourth form finger and the forming pin when the form finger is in the wrapping position.

Suitably, the apparatus is arranged such that once the fourth form finger is in the wrapping position first and second edges of the metal sheet substantially overlie one another.

Suitably, the apparatus is arranged such that once the fourth form finger has been moved to a wrapping position the second form finger can be returned to a wrapping position. The second form finger may thus cause the second edge region of the metal sheet to be wrapped over the first edge region thereof. The second edge region may be clamped over the first edge region to form a circumferentially closed tube.

Suitably, the apparatus further comprises handling means for holding the metal sheet in the tubular configuration as the form fingers are removed from engagement therewith once the tube is formed.

Suitably, the handling means comprises a collet assembly arranged to clamp the tube. Suitably, the collet assembly is arranged to engage the outside of the tube around substantially the entirety of its circumference. The collet assembly may be arranged to allow the tube to open slightly to release cleanly from around the forming pin.

Suitably, the apparatus comprises a welding station at which the bent metal sheet may be welded to secure it in a tubular configuration. The welding station suitably comprises means for laser welding.

The handling means may be arranged to convey the tube to the welding station.

Suitably, the apparatus comprises means to install a cap to the end of the tube to form a tubular body which is blind at one end.

Suitably the apparatus is arranged to install the cap before the tube is conveyed to a welding station. Suitably, the tube may be welded to the cap at the welding station.

Suitably, the handling means is arranged to locate the tube into a cap. The collet assembly may be arranged to decrease the tube diameter slightly and insert it into a cap and then allow the tube to open slightly to seat snugly in the cap. The collet assembly may then release the tube.

A further handling means may then convey the tubular body to a welding station. For example, the cap may be held by a further handling means which can convey it and the tube to a welding station.

Suitably, the apparatus is arranged to produce an electrode emission source component according to the first aspect.

The apparatus may further comprise means for attaching a stem to a cap or may be arranged to handle a cap having a stem attached thereto. The apparatus may thus be arranged to manufacture an electrode according to the second aspect.

According to a fifth aspect of the present invention there is provided a method of forming a tube, the method comprising wrapping a metal sheet around a forming pin such that the metal sheet adopts a tubular configuration substantially corresponding to the outer face of the forming pin.

Suitably, the metal sheet is wrapped around a forming pin by a plurality of form fingers. The form fingers may press the metal sheet against the forming pin to form the tube.

Suitably, the forming pin comprises a substantially circular cross section. Alternatively, the form finger may comprise a square, rectangular or triangular cross section.

The metal sheet may be such that once formed into the tubular configuration it substantially retains said configuration.

The method may comprise the step of securing the metal sheet in the tubular configuration. Said securement step may comprise welding edges of the metal sheet together in the tubular configuration.

Alternatively, or in addition, the securement step may comprise installing a cap onto the tube which may hold the metal sheet in the tubular configuration. The tube and cap may be welded together. The method may thus comprise forming a tubular body which is blind at one end.

The tubular body formed by the method may comprise an electrode emission source component according to the first aspect.

A stem may be attached to the cap and the method may thus comprise a method of manufacturing an electrode.

Suitably, the method comprises wrapping a mid region of a metal sheet around a forming pin and then wrapping a first edge region of the metal sheet around a forming pin and then wrapping the remainder of the metal sheet around the forming pin such that a second edge region of the metal sheet overlaps the first and the metal sheet forms a tube.

Suitably, the method employs an apparatus according to the fourth aspect. The method may employ any step referred to in relation to the fourth aspect.

### BRIEF DESCRIPTION OF THE DRAWINGS

The present invention will now be illustrated by way of example with reference to the accompanying drawings in which:

FIG. 1 is a perspective view of an electrode emission component;

FIG. 2 is a cross section of the electrode emission component of FIG. 1 showing hidden detail;

FIG. 3 is an end view of the electrode emission component of FIG. 1;

FIG. 4 is a plan view of a forming station of an assembly apparatus;

FIG. 5 is a detail plan view of a part of the forming station of FIG. 4;

FIGS. 6A-H are schematic representations of a tube forming operation;

FIG. 7 is a cross section of a collet assembly of a handling means;

FIG. 8 is an end view of part of the collet assembly of FIG. 7 holding a tube; and

FIG. 9 is a cross section of a cold-cathode fluorescent lamp comprising the electrode emission source component of FIGS. 1 to 3.

### DESCRIPTION OF THE PREFERRED EMBODIMENTS

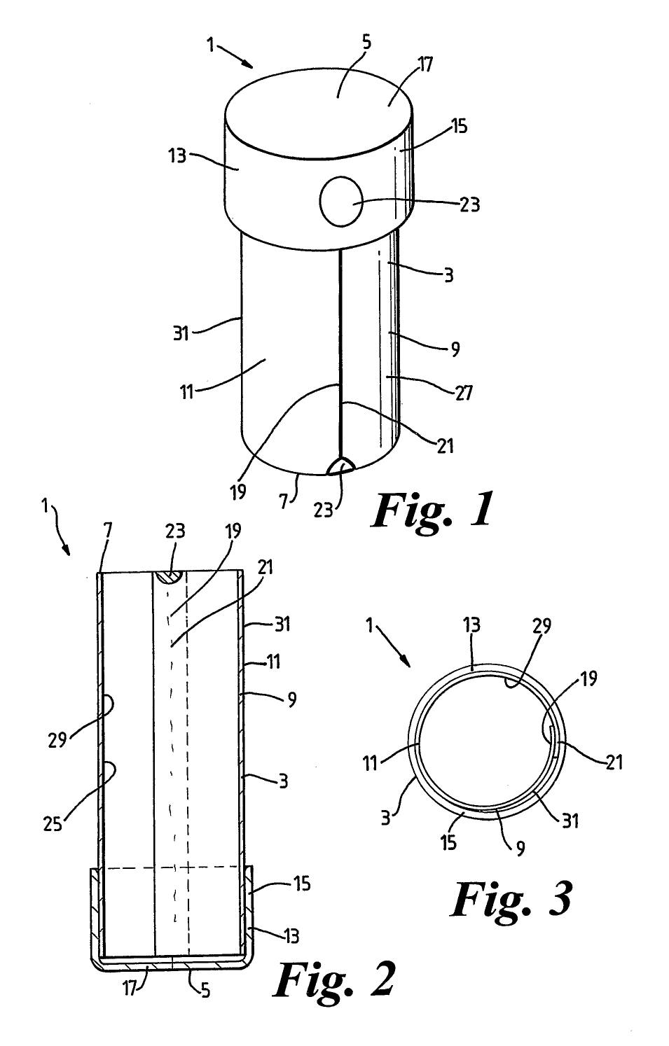

As illustrated by FIGS. 1 to 3 an electrode emission source component 1 comprises a tubular body 3 which is blind at a first end 5 and open at an opposed second end 7. The tubular body 3 comprises a tube 9 formed from a bent metal sheet 11 and a cap 13 into which the tube 9 is inserted.

The cap 13 itself comprises a tubular body which is blind at one end and comprises a cylindrical wall 15 extending from a base wall 17.

The cap 13 comprises molybdenum and is formed by deep-drawing.

The metal sheet 11 comprises molybdenum and is fabricated into a tube 9 by being bent. The metal sheet 11 is bent such that first and second edge regions 19, 21 thereof overlap. A first side 25 of the metal sheet forms an inner face 29 of the electrode emission source component 1 and a second side 27 forms an outer face 31 thereof.

The cap 13 and tube 9 are laser welded at weld points 23 to secure the cap 13 to the tube 9 and to retain the metal sheet 11 in a tubular configuration. A first weld point is located within a zone in which the cap 13 and edge regions 19, 21 of the tube 9 overlap. Two further weld points are spaced around the cap 13 within a zone which overlaps with the tube 9 such that they lie approximately 120 degrees either side of the first weld point. An additional weld point is located at the second end 7 of the tubular body 3 within a zone in which the edge regions 19, 21 overlap.

The electrode emission source component 1 has a length of around 5 mm and a diameter of around 1 mm.

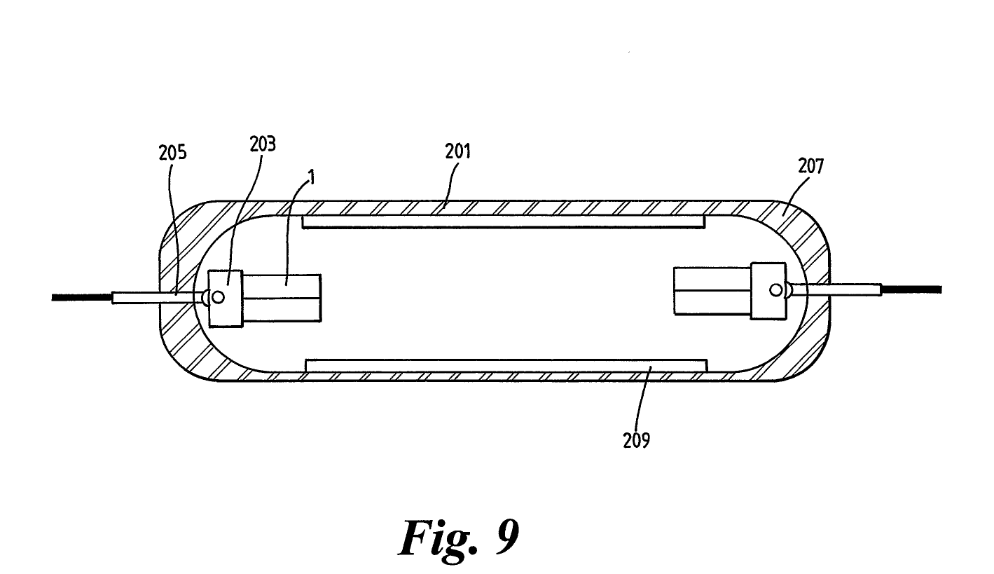

FIG. 9 illustrates a cold cathode fluorescent lamp 201 comprising an electrode 203 comprising electrode emission source components 1 each having a stem 205 attached thereto. The lamp 201 comprises a glass body (housing) 207 through which the stems 205 extend. The interior of the glass body 207 is provided with a phosphor coating 209 and the body 207 is evacuated and charged with a small quantity of mercury.

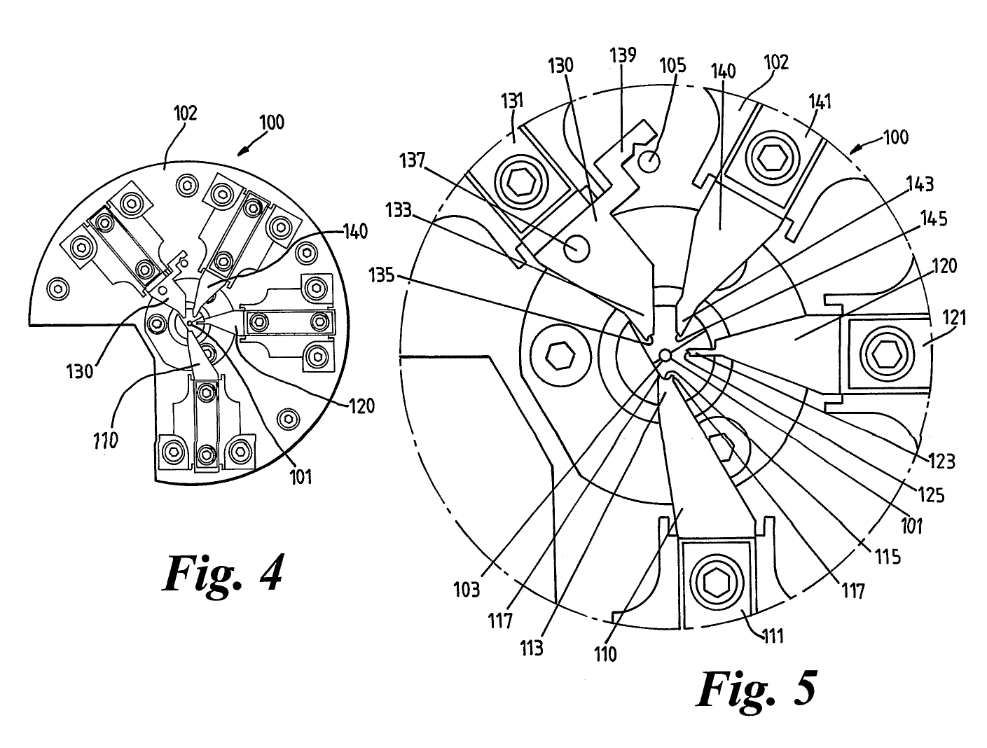

The tube 9 can be fabricated using apparatus illustrated by FIGS. 4 and 5.

The apparatus 100 comprises a forming station 102 comprising a pin 101 having a substantially circular cross section and which is orientated such that its axis extends substantially vertically. Arranged around the forming pin 101 at the forming station 102 are first, second, third and fourth form fingers 110, 120, 130 140. Each form finger 110, 120, 130, 140 is mounted upon an actuator 111, 121, 131, 141 arranged to move the respective form finger substantially linearly and perpendicularly relative to the axis of the forming pin 101.

Each form finger 110, 120, 130, 140 comprises a tip 113 123, 133, 143 having a forming face 115, 125, 135, 145 comprising a convex arc. Said forming faces are arranged to generally correspond to the outer face 103 of the forming pin.

In use, the form fingers 110, 120, 130, 140 are moveable to wrapping positions in which they can cause a metal sheet to be bent around the forming pin 101. The form fingers are radially spaced from one another around the forming pin 101 such that when in a wrapping position their forming faces form a ring, which has only minor gaps, around the forming pin 101.

As well as being moveable relative to the forming pin 101 the third form finger 130 is also pivotable relative to the third actuating means 131. This is achieved by the third form finger 130 being mounted to the third actuating means about a pivot 137. The third form finger 130 is also provided with an arm 139 arranged to engage an engagement pin 105 as the tip of the form finger is moved towards the forming pin 101. The engagement pin 105 is axially fixedly positioned relative to the forming pin 101. Thus, in use, as the arm engages the actuating pin it is restricted from moving towards the forming pin 101, continued movement of the third form finger 130 towards the forming pin 101 by the actuator 131 thus causes the form finger 130 to rotate about pivot 137. The tip 133 of the third form finger 130 may thus follow an arcuate path as it approaches the forming pin 101. This movement may, in use, minimise any kinking of the metal sheet as it is bent around the forming pin 101.

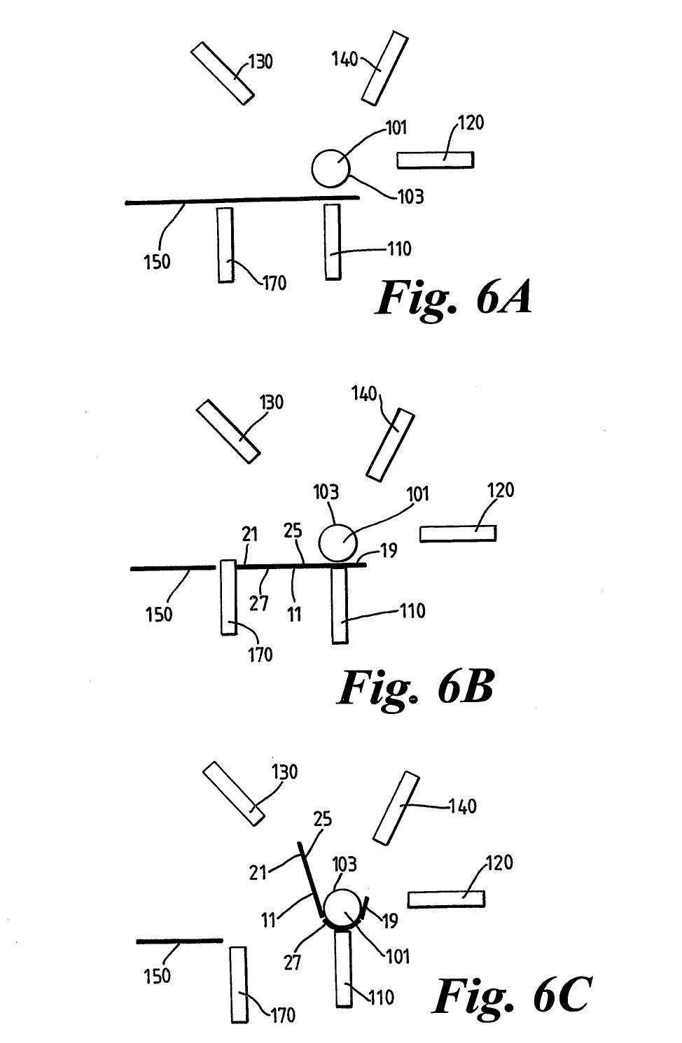

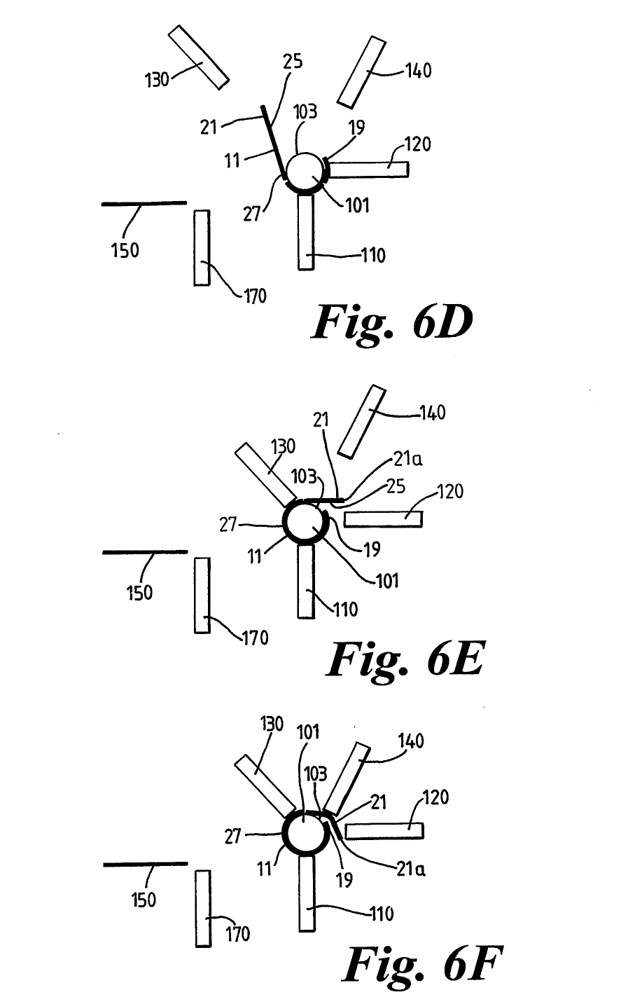

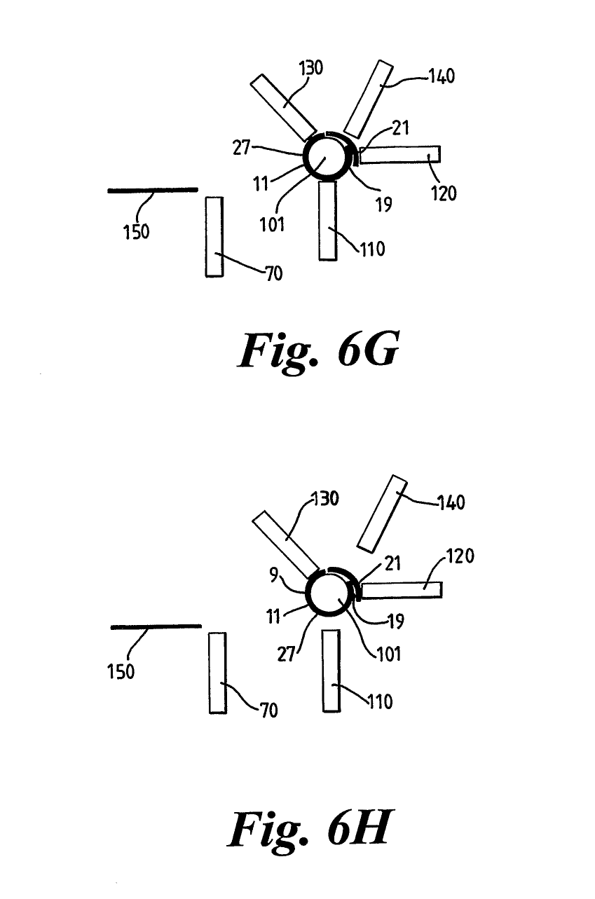

In addition to the forming station 102 the apparatus comprises feed means (not shown) for feeding metal tape 150 from a supply of tape to the forming station. A cutter 170 (shown schematically in FIGS. 6A-G) is provided to cut a length from the tape 150 to provide a metal sheet 11.

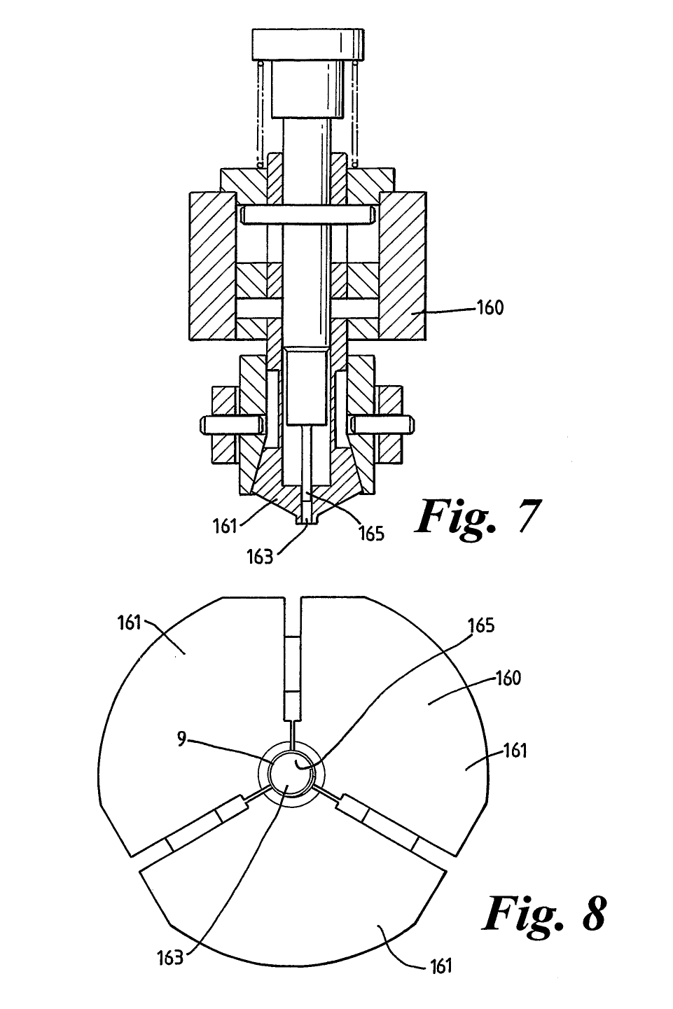

The apparatus also comprises a handling means for conveying a formed tube from the forming station 102. The handling means comprises a collet assembly 160 (illustrated by FIGS. 7 and 8) arranged to hold the metal sheet 11 in a tubular configuration once the tube 9 is formed.

The collet assembly 160 comprises three segments 161 arranged to form a circular aperture 163 at their centre to receive the tube 9 and lightly grip it. The collet assembly 160 may thus convey the tube 9 substantially without deforming it. To release the tube 9 the segments 161 can be moved apart to enlarge the aperture 163. The collet assembly further comprises an ejector pin 165 for pushing the tube 9 from the collet assembly's grip.

To provide the electrode emission source component illustrated by FIGS. 1 to 3 the apparatus is arranged such that the collet assembly 160 inserts an end of the tube 9 into a cap 13 and then releases the tube 9. The tube 9 can then open out slightly to seat snugly in the cap 13. The apparatus further comprises a further handling means (not shown) arranged to convey the cap and tube to a welding station (not shown) to secure them together and secure the metal sheet 11 in a tubular configuration.

In an alternative embodiment, not illustrated, the apparatus may form a tube 9 having no cap by conveying a bent metal sheet 11 to a welding station to secure the sheet in a tubular configuration.

The tube forming process is best illustrated by FIGS. 6A-H which schematically represent the movement of the form fingers.

To form a tube 9 from a metal sheet 11 a length of tape 150 is first fed to a forming station 102 with the forming pin 101 and form fingers 110, 120, 130, 140 arranged generally as illustrated by FIG. 6A.

As illustrated by FIG. 6B the first form finger 110 then moves toward the forming pin 101 to adopt a clamping position in which the tape 150 is held between the form finger and forming pin. When the first form finger 110 is in the clamping position only prongs 117 on the tip 113 of the form finger (defining edges of the forming face 115) engage the tape 150. Thus the tape is substantially un bent. With the tape 150 clamped between the form finger and forming pin the cutter 170 moves to a cutting position to cut a length from the tape 150 to provide a metal sheet 11 which is substantially planar and has opposed first and second edge regions 19, 21.

As illustrated by FIG. 6C the cutter 170 then retracts to a non-cutting position and the first form, finger 110 moves closer to the forming pin 101 to reach a wrapping position. When the form finger is in the wrapping position a first (inner) face 25 of the metal sheet 11 is pressed against the forming pin 101 and a second (outer) face 27 of the metal sheet is pressed against the forming face 115 of the first forming finger 110. A mid region of the metal sheet 11 is thus caused to wrap around the forming pin 101.

As illustrated by FIG. 6D the second form finger 120 is then moved to a wrapping position in which the first edge region 19 of the metal sheet 11 is pressed between the outer face 103 of the forming pin 101 and the forming face 125 of the second form finger. The edge region 19 is thus wrapped around the forming pin 101.

Next, as illustrated by FIG. 6E the third form finger 130 is moved to a wrapping position in which a further mid-region of the metal sheet 11 is pressed between the outer face 103 of the forming pin 101 and the forming face 135 of the second forming finger. The further mid-region is thus wrapped around the forming pin 101. The second form finger 120 is removed from engagement with the metal sheet 11 at this time such that it does not subsequently interfere with the wrapping of the remainder of the metal sheet 11.

As illustrated by FIG. 6F the fourth form finger 140 then moves to a wrapping position in which a region near the second edge 21a of the metal sheet 11 is pressed between the outer face 103 of the forming pin 101 and the forming face 145 of the fourth forming finger. The metal sheet 11 is thus wrapped around the forming pin 101 such that the second edge region 21 overlies the first edge region 19.

To complete the tube 9 the second form finger is returned to a wrapping position as illustrated by FIG. 6G such that the second edge region 21 of the metal sheet 11 is pressed between the outer face 103 of the forming pin 101 and the forming face 145 of the second forming finger. The second edge region 21 of the metal sheet and the forming pin 101 are interposed by the first edge region 19 of the metal sheet 11 and thus the metal sheet 11 is wrapped to form a tube 9.

As shown by FIG. 6H the first and fourth form fingers 110, 140 are taken out of engagement with the metal sheet 11 such that the metal sheet 11 is held in a tubular configuration by the second and third form fingers 120, 130 and the forming pin 101.

To form an electrode component the following steps are then performed.

The collet assembly 160 is located over the forming pin in an open configuration. The forming pin 101 then raises substantially vertically lifting the tube 9 partially clear of the second and third form fingers 120, 130 and into the aperture 163 of the open collet assembly 160. The second and third form fingers 120, 130 are then moved away from the tube 9 which thus expands slightly into the open collet assembly 160. The forming pin 101 is then lowered away from the tube. The collet assembly 160 then closes to reduce the aperture 163 and thus tube 9 to a diameter which is slightly smaller than that of a cap 13 into which the tube 9 is to be inserted.

The collet assembly 160 then conveys the tube 9 to a cap 13 and an ejector pin 165 ejects the tube 9 into the cap 13 and the collet assembly 160 opens to enlarge aperture 163 and withdraws. The tube 9 is pushed into the cap 13 to the required extent to control the overall length of the tubular body 3 thus formed and then a welding operation is performed.

A polycrystalline diamond pin (not shown) is inserted into the open end of the body 3 for the full length of the body 3 to act as a heat and vapour sink. A gas mixture of 90% Nitrogen and 10% Hydrogen or Argon is then applied as a shielding/reducing gas. Three laser spot welds 23 are then produced simultaneously through the cap 13 into the tube 9, 120 degrees apart with one weld 23 centred on the overlapping edges 19, 21 of the metal sheet 11 of the tube 9. The polycrystalline diamond pin is then removed from the component.

The open end of the tubular body 3 is then clamped using two semi circular control jaws (not shown) to give the correct diameter and shape and a laser spot weld is produced perpendicular to the tube 9 centred on the overlapping edges 19, 21 of the metal sheet 11 adjacent the open second end 7.

It will be appreciated that electrode emission source components according to preferred embodiments of the present invention may be advantageous. In particular, they may be efficient to produce and may have enhanced lifetimes compared to known components.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiments(s). The invention extends to any novel one, or any novel combination, of the features disclosed in this specification (including any accompanying claims, abstract and drawings), or to any novel one, or any novel combination, of the steps of any method or process so disclosed.

1. An apparatus for forming a tube by bending a metal sheet, the apparatus comprising a forming station comprising a forming pin around which said metal sheet can be wrapped and a plurality of form fingers radially spaced around the forming pin and moveable relative to the forming pin for wrapping the metal sheet around the forming pin.

2. An apparatus according to claim 1, wherein the apparatus comprises first, second, third and fourth form fingers each of which is moveable to a wrapping position in which it can cause the metal sheet to bend around the forming pin.

3. An apparatus according to claim 1, wherein the apparatus is arranged such that during the tube forming process at any given time whilst the metal sheet is being wrapped around the forming pin a part of the metal sheet is clamped between the forming pin and a form finger.

4. An apparatus according to claim 1, wherein the apparatus comprises feed means arranged to feed a metal sheet to the forming station.

5. An apparatus according to claim 1, wherein the apparatus comprises a cutter arranged to cut a length of tape from a supply of tape to provide a metal sheet which can be formed into a tube and wherein a first form finger is moveable to a clamping position such that it can clamp the metal tape against the forming pin to hold it in position substantially without deforming the tape whilst a length of tape is cut by a cutter to form the metal sheet.

6. An apparatus according to claim 1, arranged to wrap the metal sheet around the forming pin to form a U shaped arc, a second form finger is arranged to engage a first edge region of the metal sheet, a third form finger is arranged to engage the metal sheet between a mid region, engaged by a first form finger, and a second edge region of the metal sheet and a fourth form finger is arranged to engage the metal sheet near to a second edge region thereof.

7. An apparatus according to claim 1, wherein the apparatus is arranged such that a second form finger is removed from contact with the metal sheet before a fourth form finger engages the metal sheet and such that first and third form fingers remain in contact with the metal sheet and wherein the apparatus is arranged such that once the fourth form finger is in a wrapping position first and second edges of the metal sheet substantially overlie one another.

8. An apparatus according to claim 1, wherein the apparatus is arranged such that once the fourth form finger has been moved to a wrapping position the second form finger can be returned to a wrapping position and wherein the second edge region of the metal sheet can be clamped over the first edge region by the second form finger to form a circumferentially closed tube.

9. An apparatus according to claim, 1 wherein the apparatus further comprises handling means for holding the metal sheet in the tubular configuration as the form fingers are removed from engagement therewith once the tube is formed.

10. An apparatus according to claim 1, wherein the apparatus further comprises handling means for holding the metal sheet in the tubular configuration as the form fingers are removed from engagement therewith once the tube is formed and the handling means comprises a collet assembly arranged to clamp the tube.

11. An apparatus according to claim 1, wherein the apparatus comprises a welding station at which the bent metal sheet may be welded to secure it in a tubular configuration.

12. An apparatus according to claim 1, wherein the apparatus comprises means to install a cap to the end of the tube to form a tubular body which is blind at one end and wherein the apparatus is arranged to weld the tube to the cap at a welding station.

13. An apparatus according to claim 1, wherein the apparatus is arranged to produce an electrode emission source component.

14. An apparatus according to claim 1, wherein the apparatus is arranged to produce an electrode emission source component and the apparatus further comprises means for attaching a stem to a cap or is arranged to handle a cap having a stem attached thereto such that it can manufacture an electrode.

15. An electrode emission source component comprising an open ended tube and a cap, wherein the tube is formed from a metal sheet which is formed into a tubular configuration and the cap is located onto the tube to form a tubular body which is blind at one end.

16. A component according to claim 15, wherein the component has an outer diameter of between 0.5 and 5 mm and wherein the length of the tube is at least 5 times its diameter.

17. A component according to claim 15, wherein first and second edge regions of the metal sheet overlap by between 0.1% and 10% of the circumference of the tube, when formed into the tube and wherein the cap is located over the tube such that the cap overlaps an end region of the tube by between 0.1 and 30% of the tube length.

18. A component according to claim 15, wherein the component comprises one or more welds to secure the bent metal sheet in a tubular configuration and wherein the cap is secured to the tube by one or more welds.

19. A component according to claim 15, wherein the tube comprises a metal sheet which comprises a metal selected from the group consisting of Nickel (Ni), Molybdenum (Mo), Niobium (Nb), Tantalum (Ta) and Tungsten (W).

20. A component according to claim 15, wherein the cap comprises a metal selected from the group consisting of Nickel (Ni), Molybdenum (Mo), Niobium (Nb), Tantalum (Ta) and Tungsten (W).

21. A component according to claim 15, wherein the cap and tube comprise the same metal.

22. A component according to claim 15, wherein the cap and tube comprise distinct metals.

23. A component according to claim 15, wherein the inner face of the electrode component comprises a surface coating and wherein the tube comprises a metal sheet which is provided with a surface coating on a first side and then formed into a tube such that said first side forms the inner face of the tube.

24. A component according to claim 15, wherein the outer face of the electrode component comprises a surface coating and wherein the tube comprises a metal sheet which is provided with a surface coating on a second side and then formed into a tube such that said second side forms the outer face of the tube.

25. A component according to claim 15, wherein the component comprises a surface coating which comprises a metal which has a higher activity than the metal forming the component part that it coats.

26. An electrode comprising an electrode emission source component according to claim 15 and a stem attached to the cap of the electrode emission source component.

27. An electrical apparatus comprising an electrode comprising an electrode emission source component according to claim 15 and a stem attached to the cap of the electrode emission source component.

28. A method of forming a tube, the method comprising wrapping a metal sheet around a forming pin such that the metal sheet adopts a tubular configuration substantially corresponding to the outer face of the forming pin.

29. A method according to claim 28, wherein the metal sheet is wrapped around a forming pin by a plurality of form fingers.

30. A method according to claim 28, wherein the method comprises the step of securing the metal sheet in the tubular configuration.

31. A method according to claim 28, wherein the method comprises the step of securing the metal sheet in the tubular configuration and wherein said securement step comprises welding edges of the metal sheet together in the tubular configuration and installing a cap onto the tube which holds the metal sheet in the tubular configuration and wherein the tube and cap are welded together.

32. A method according to claim 28, wherein the method comprises forming a tubular body which is blind at one end.

33. A method according to claim 28, wherein the method comprises forming a tubular body which is blind at one end and the tubular body formed by the method comprises an electrode emission source component comprising an open ended tube and a cap, wherein the tube is formed from a metal sheet which is formed into a tubular configuration and the cap is located onto the tube to form a tubular body which is blind at one end.

34-55. (canceled)
